(19) United States
(12) Patent Application Publication
(10) Pub. No.: US 2018/0225729 A1
(43) Pub. Date: Aug. 9, 2018

(54) COST-BASED LICENSE MANAGEMENT METHODS FOR USE IN A LICENSE MANAGEMENT SYSTEM

(71) Applicant: Quanta Computer Inc., Taoyuan City (TW)

(72) Inventors: Tu-Jung LI, Taoyuan City (TW); Chen-Chung LEE, Taoyuan City (TW); Chia-Hung LIN, Taoyuan City (TW); Ming-Jen CHEN, Taoyuan City (TW); Hung-Yu YANG, Taoyuan City (TW)

(21) Appl. No.: 15/611,866

(22) Filed: Jun. 2, 2017

(30) Foreign Application Priority Data
Feb. 6, 2017 (TW) 106103785

(51) Int. Cl. G06Q 30/02; G06F 21/10; G06Q 30/06

(52) U.S. Cl. CPC G06Q 30/0283; G06Q 30/06; G06F 21/105

(57) ABSTRACT

Cost-based license management methods for use in a license management system that manages licenses and respective costs of using license are provided. The method includes the steps of: setting a peak-hour period according to historical using record of licenses; determining whether the peak-hour period is reached and whether a usage rate for the licenses being used in the peak-hour period is higher than a upper limit; using first rate to calculate cost of using license for all of the licenses being used when the peak-hour period has not been reached or the usage rate for the licenses in the peak-hour period is lower than the upper limit; and using second rate higher than the first rate to calculate the cost of using license for part of the licenses being used when the usage rate for the licenses in the peak-hour period is higher than the upper limit.

### CROSS REFERENCE TO RELATED APPLICATIONS

This Application claims priority of Taiwan Application No. 106103785, filed on Feb. 6, 2017, and the entirety of which is incorporated by reference herein.

### BACKGROUND OF THE INVENTION

### Field of the Invention

The invention generally relates to license management systems and related methods, and more particularly, to license management systems and related cost-based license management methods thereof capable of managing the obtaining and releasing of a given number of licenses.

### Description of the Related Art

License distribution is used to manage a variety of licenses, such as the obtaining and releasing of a software license, to distribute limited number of licenses to be used by multiple users or devices. Users must first obtain a license for using specific software from the license server to use that software, so those who require licenses from the license server first will obtain the licenses first.

In general, particular software has a specific time of use, including a time period and urgency level for the use. If the user's usual time of use is concentrated in the same time period, the so-called “peak-hour period” results. During a peak-hour period, everyone has access to limited software resources at the same time, thus the high software utilization and often causing the license server to be in full load. When the license server is fully loaded, no license will be available for use, thus resulting in short supply. Conversely, the software usage rate during non-peak-hour period is relatively low. In addition, there is limited room for the optimization of software resources during the peak-hours. Therefore, there is a need for providing a method and system that can effectively distribute software request as well as adding more room for the optimization of software resources during the peak-hour periods.

### BRIEF SUMMARY OF THE INVENTION

Accordingly, embodiments of the invention provide license management systems and related cost-based license management methods thereof for managing the obtaining and releasing of a given number of licenses. In one aspect of the invention, a cost-based license management method for use in a license management system is provided. The license management system manages a plurality of licenses and calculates respective costs of using license. The method includes the steps of: setting a peak-hour period according to historical using record of the licenses; determining whether the peak-hour period is reached and whether a usage rate for the licenses being used in the peak-hour period is higher than a upper limit; using a first rate to calculate the cost of using license for all of the licenses being used when the peak-hour period has not been reached or the usage rate for the licenses being used in the peak-hour period is lower than the upper limit; and using a second rate higher than the first rate to calculate the cost of using license for part of the licenses being used when the usage rate in the peak-hour period is higher than the upper limit.

Other aspects and features of the present invention will become apparent to those with ordinarily skill in the art upon review of the following descriptions of specific embodiments of cost-based license management methods for use in a license management system.

### BRIEF DESCRIPTION OF DRAWINGS

The invention can be more fully understood by reading the subsequent detailed description and examples with references made to the accompanying drawings, wherein:

FIG. 1 is a schematic diagram illustrating an embodiment of a license management system of the invention;

FIG. 2 is a flow chart illustrating a cost-based license management method according to an embodiment of the invention;

FIG. 3 is a flow chart illustrating a cost-based license management method according to yet another embodiment of the invention; and

FIG. 4 is a flow chart illustrating a cost-based license management method according to still another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense.

Embodiments of the invention provide license management systems having a cost of using a license and related license management methods thereof, to manage the way of obtaining and releasing a license. Through differential pricing for non-peak hours and peak-hours, the software utilization demand during the peak-hour periods can be effectively dispersed. In addition, in view of the user's past utilization status, when the license quantity falls short, users with higher utilization are first requested to release the license, thereby achieving average license fairness and more effectively utilizing all licenses.

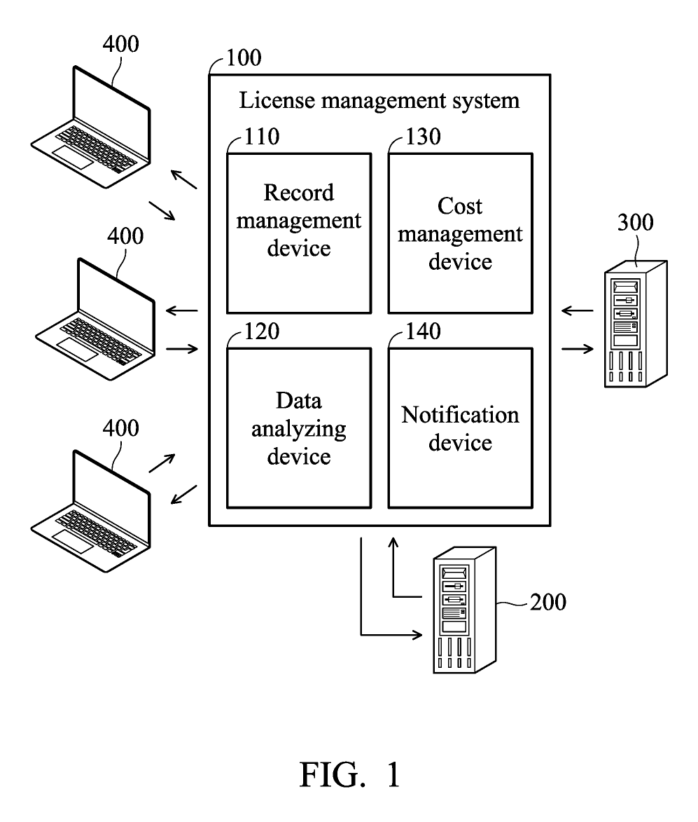

FIG. 1 is a schematic diagram illustrating an embodiment of a license management system of the invention. The license management system 100 of the invention can be an electronic device, such as a PDA (Personal Digital Assistant), a smart phone, a mobile phone, an MID (Mobile Internet Device, MID), a laptop computer, a car computer, a digital camera, a multi-media player, a game device, or any other type of mobile computational device, however, it is to be understood that the invention is not limited thereto. The license management system 100 may be further coupled to one or more servers, such as a license server 200 and a data server 300 for performing license management. For example, the license management system 100 may be coupled to the license server 200 and the data server 300 via any wired/wireless communications networks, such as the INTERNET, WCDMA, 3G, and/or WLAN network, blue-tooth network and so on to perform communication and data transmission therebetween. The license server 200 may include a license pool, in which a given number of licenses can be distributed and the relevant data can be recorded, such as a list of licensed users currently using the licenses, a list of users with license permissions and the regulations related to licenses and so on. The data server 300 may include user-related data and the historical records of the use of its licenses, such as the list of all users and data, the records of the use of licenses (also referred to as the records of license usages) and so on. The license management system 100 may communicate with the license server 200 and the data server 300 to receive the license requests from one or more devices 400, and manage the obtaining and releasing of the licenses in the license pool of the license server 200 based on the license management method of the invention. Each device 400 corresponds to a user. When the user of a device 400 is a licensed user who is using the license currently, the device 400 can also be referred to a license usage device.

The license management system 100 may at least comprise a record management device 110, a data analyzing device 120, a cost management device 130, and a notification device 140. The record management device 110 is used to record the historical records of the license usages and store the historical records of the license usages on the data server 300. For example, in some embodiments, the historical records of the license usages may include the total number of hours of use of the software license for each user yesterday, the total number of hours of use of the software license for this week, the total number of hours of use of the software license this month and the like, but the invention is not limited thereto. The data analyzing device 120 can obtain the historical records of the license usages (e.g., records of the license usages for all the users) from the data server 300 through the record management device 110, and analyzes the historical records of the license usages to obtain an analyzed data, based on an algorithm that comprehensively considers the past use conditions of each user and the historical records of license usages. The cost management device 130 can calculate a rate for calculating cost of using license corresponding to all the users currently using the licenses through the analyzed data obtained by the data analyzing device 120. Users with longer use time in the past fall under a higher corresponding rate. The notification device 140 may send/issue a notification message to a license request device. The notification message may include information regarding rate prompt information and other information.

It should be understood by those who are skilled in this technology that the record management device 110, the data analyzing device 120, the cost management device 130 and the notification device 140 may have sufficient hardware circuits, elements and/or software, firmware, and combinations thereof to achieve the desired functionality, which may be implemented in software, hardware, or a combination thereof. For example, the record management device 110, the data analyzing device 120, the cost management device 130 and the notification device 140 may have appropriate hardware circuits and software program codes to perform the related operations, respectively.

In some embodiments, the license management system 100 may further comprise a storage unit (e.g. a high-speed random access memory (e.g. SRAM or DRAM) and/or non-volatile memory, such as flash memory) (not shown), which may include one or more types of computer readable medium, which stores related data, such as license-related data, user-related data and so on.

The license management system 100 can perform the license management method of the present invention for managing license usage and costs related to license usage, which will be discussed further in the following paragraphs. To be more specific, the license management system 100 can perform the license management method of the present invention through the aforementioned record management device 110, the data analyzing device 120, the cost management device 130 and the notification device 140 to dynamically and statistically analyze the license usage within the peak-hour periods and selectively increase the license usage costs of some users during the peak-hour periods. Through this distribution mechanism, the license usage status during the peak-hour periods can be dynamically adjusted to reasonably average the license usage.

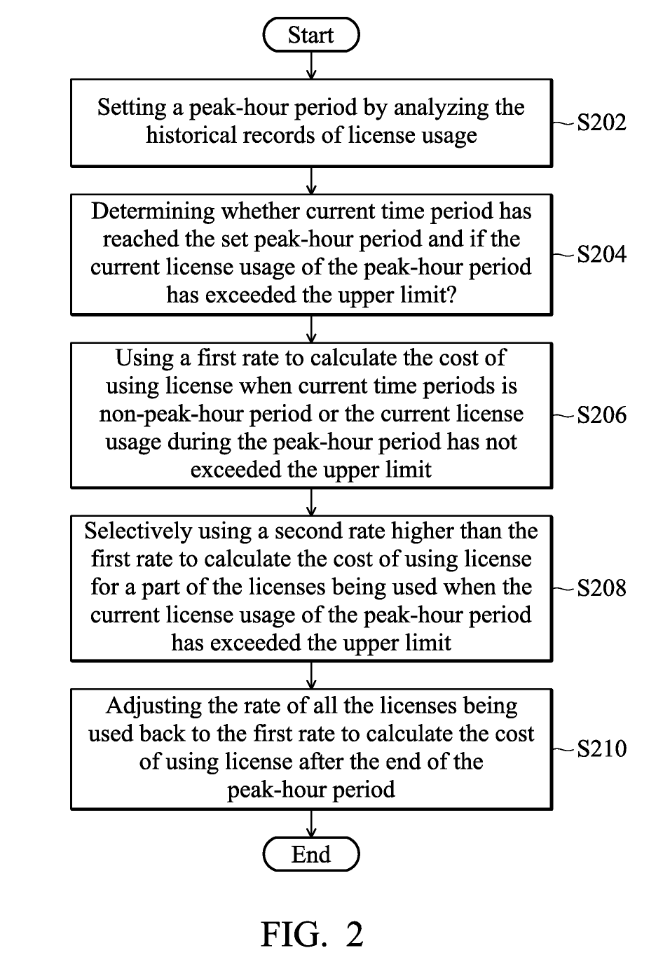

FIG. 2 is a flowchart of an embodiment of a cost-based license management method of the invention. The cost-based license management method can be applied to a license management system such as the license management system 100 of FIG. 1, which can be an electronic device, such as a PDA, a smart phone, a mobile phone, an MID, a laptop computer, a car computer, a digital camera, a multi-media player or a game device, or any other type of mobile computational device, however, it is to be understood that the invention is not limited thereto. In this embodiment, it is assumed that the license management system 100 comprises the record management device 110, the data analyzing device 120, the cost management device 130 and the notification device 140 and it is coupled to the license server 200 and the data server 300 for performing license management on a given number of licenses in the license pool of the license server 200, in which one or more of licensed license usage devices are using one of the given number of licenses and each user of the licensed license usage devices is required to pay a specified cost for license usage.

First, in step S202, the license management system 100 configures/sets a peak-hour period based on the historical records of the license usages. To be more specific, the license management system 100 can obtain historical records of the license usages through the record management device 110 and analyze the records of the software license usages through the data analyzing device 120 in order to find the peak-hour period of software usage within certain time periods (such as daily, weekly, monthly, quarterly, yearly, etc.). The peak-hour period can be calculated by year/season/month/week/day. In one embodiment, the peak-hour period can be determined by the average license usage history of respective candidate time periods. For example, if each day is divided into multiple candidate time periods with one hour as the unit, when the average license usage of a software within a specific time period has exceeded an upper limit (e.g. if the average utilization of 97% from 9:00 a.m. to 10:00 a.m. during work days in March is higher than an upper limit of 95.4%, the time period from 9:00 a.m. to 10:00 a.m. can be set as the peak-hour period for April). In another embodiment, the peak-hour period can also be determined based on the history of frequency and/or number of people that failed to obtain the license in respective candidate time periods. For example, the peak-hour period can be set when the frequency and/or number of people that failed to obtain the software license within a specific time period has exceeded the upper limit (e.g., from 9:00 a.m. to 10:00 a.m. during work days in March, if the frequency of failing to obtain software license reaches 109 times, exceeding the upper limit of 100 times, or the number of people failing obtain software license reach 23 people, exceeding the target value of 20 people, the time period from 9:00 a.m. to 10:00 a.m. is set as the peak-hour period for April). After completing the peak-hour period setting, the license management system 100 can start calculating the time of license usage for each user and calculate the cost for license usage based on the time the user uses the license. When the user uses the license during a non-peak-hour period, the license management system 100 can calculate the cost of using license based on a first rate (e.g., a basic rate). On the other hand, when the user uses the license during a peak-hour period, the license management system 100 will selectively calculate the costs of using license for a subset of the users using the licenses based on a second rate (e.g., a weighted rate, which is higher, usually one or two times higher, than the basic rate). For example, if the first rate is set as 1 dollar per minute, the second rate may be set between 1 and 2 dollars per minute, and the second rate of each user varies from person to person. Thereafter, the license management system 100 then calculates cost of using license based on the time period in use. It should be understood that, in some embodiments, two or more time periods may be set as peak-hour periods and the peak-hour periods for each cost calculation cycle may vary. For example, the peak-hour periods may be set as 9:00 to 10:00 in the morning and 5:00 to 6:00 in the evening. Moreover, the peak-hour periods for the first week and the peak-hour periods for the second week in every month may be set to different time periods.

In step S204, the license management system 100 then determines whether the current time period has reached the set peak-hour period and if the current license usage of the peak-hour period has exceeded the upper limit. For example, if the peak-hour period is set as within one hour from 9:00 a.m. to 10:00 a.m. and the upper limit of the license usage is set as 95%, the determination of whether the current time period has reached the set peak-hour period and if the current license usage of the peak-hour period has exceeded the upper limit is to determine if the current time is close to 9:00 a.m. (e.g., from 8:45 to 9:00) and if the license usage at this time has exceeded 95%.

When current time is not a peak-hour period (i.e., a non-peak-hour period) or the current license usage during the peak-hour periods has not exceeded the upper limit (e.g., the current time is 8:00 or 9:00, and the usage rate is 90%) (No in step S204), in step S206, the license management system 100 calculates the cost of using license using the first rate.

In contrast, when the current time period is a peak-hour period and the current license usage of the peak-hour period has exceeded the upper limit (e.g., the current time is between 9:00 and 10:00 and the current license usage is 97%), in step S208, the license management system 100 selectively uses the second rate to calculate the cost of using license for a part of the licenses being used, wherein the second rate is higher than the first rate.

In some embodiments, the number of targets selected to be calculated with the second rate is determined based on the upper limit and the usage rate and the selection is based on the usage ranking value corresponding to respective user. Specifically, the step that the license management system 100 selectively uses the second rate to calculate the cost of using license for a part of the licenses being used may include at least the following steps: calculating the number of targets selected to be calculated with the second rate based on the upper limit and obtaining a sequence result for the licensed users according to each licensed user's individual historical record of license usage; and selecting one or more users from the licensed users to calculate the cost of using license with respective second rate based on the number of targets and the ranking result, until the license usage is lower than the upper limit. For example, the license management system 100 may calculate the number of target users who are expected to use weighted cost based on the upper limit, and rank the users currently using the licenses according to the user's historical record of license usage. One or more users are then selected based on the respective ranking value. In other words, users with heavier usage in the past have lower ranking values, thus the higher probability of second rate being used. Detail descriptions on the calculation of ranking value, the second rate, and the associated algorithm and how to selectively calculate the cost of using license for a part of the licenses being used with respective second rate will be discussed further in the following paragraphs.

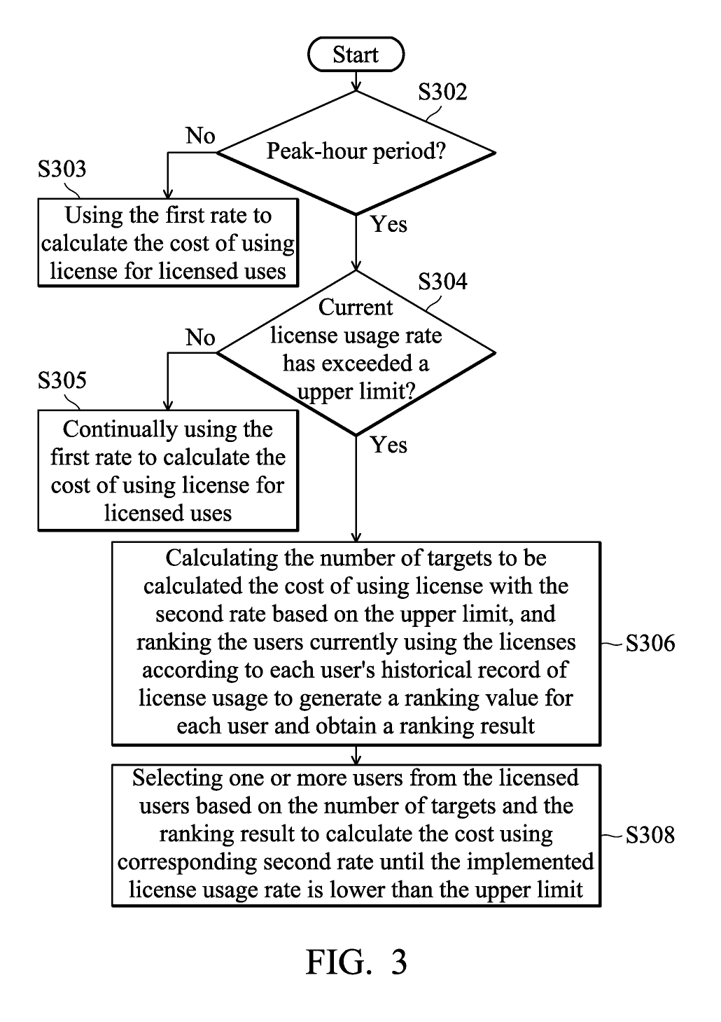

FIG. 3 is a flowchart of an embodiment of a license management method of the invention. The license management method can be applied to a license management system such as the license management system 100 of FIG. 1, which can be an electronic device, such as a PDA, a smart phone, a mobile phone, an MID, a laptop computer, a car computer, a digital camera, a multi-media player or a game device, or any other type of mobile computational device, however, it is to be understood that the invention is not limited thereto. In this embodiment, it is assumed that the license management system 100 comprises the record management device 110, the data analyzing device 120, the cost management device 130 and the notification device 140 and it is coupled to the license server 200 and the data server 300 for performing license management on a given number of licenses in the license pool of the license server 200, in which one or more of first devices (i.e., license usage devices) are using one of the given number of licenses.

First, the license management system 100 determines whether or not the preset peak-hour period is about to begin (step S302). For example, if the peak-hour period is set to a time period from 9:00 to 10:00, determination of whether the preset peak hour is about to begin is to determine whether the current time is close to 9:00 (for example, a time period between 8:45 and 9:00). In one embodiment, when the current time is between 8:45 and 9:00, the preset peak-hour period is about to begin.

If time being calculated is not at the peak-hour period (No in step S302) (e.g., a time point before 8:45 am), the license management system 100 uses the first rate to calculate the cost of using license (step S303). For example, each user who uses a license should pay a cost of 1 dollar per minute.

If the peak-hour period is about to begin (Yes in step S302) (for example, the time is between 8:45 and 9:00), the license management system 100 then checks whether current license usage rate (i.e., the number of licenses being currently used) has exceed a upper limit (e.g., 95%) (step S304). When the current license usage rate has not exceeded the upper limit (No in step S304), the license management system 100 does not start the weighting cost calculation mechanism and continues to use the first rate to calculate the cost of using license (step S305). That is, when the current license usage rate in the peak-hour period does not exceed the upper limit, the cost of each user who uses a license is maintained at 1 dollar per minute.

Contrarily, when the current license usage rate has exceeded the upper limit (Yes in step S304), the license management system 100 starts the weighting cost calculation mechanism and calculates the number of target users who are expected to use the weighted cost based on the upper limit and ranks the users currently using the licenses according to each user's historical record of license usage (step S306).

The license management system 100 may periodically (e.g., daily) calculate weighting factors of all the users, and use the weighting factors to perform a user usage amount weighting calculation to rank/sort all the users according to each user's usage amount. For example, in one embodiment, the user usage amount weighting calculation T may be determined with reference to the historical records of license usage time for all the users.

In some embodiments, the calculation of the second rate can be performed by using an algorithm that comprehensively considers individual license usage statuses of each user in the past, so as to obtain their ranking values and weighting factors. In some embodiments, individual license usage historical record of each user may include at least one or more of the following statistic data of historical records of license usage:

a total time the user spent on using license yesterday;

a total time the user spent on using license in the past 7 days (current week);

a total time the user spent on using license in the past 30 days (current month); and so on. The higher the usage time is, the lower the ranking value is.

For example, but not limited to, the usage amount T of a user can be calculated by the following algorithm:

T=T1*0.6+T2/7*0.3+T3/30*0.1,

in which T1 represents the total time the user spent on using license yesterday, T2 represents the total time the user spent on using license in the past 7 days (this week) and T3 represents the total time the user spent on using license in the past 30 days (this month). In some embodiments, the importance of each weighting factor may be adjusted according to a license policy. For example, when the license policy is mainly consider the total time the user spent on using license in this week, T2 can be set to be 0.6 while T1 and T3 are set to be 0.3 and 0.1 respectively, so as to emphasize the importance of the total time the user spent on using license in this week in the weighting cost calculation. Thereafter, a ranking result can be generated by using the usage amount T of each user to rank all the license users from high to low, and the higher the usage amount T of the user is, the lower the ranking value is.

Particularly, each user has a corresponding ranking value in the ranking result and the respective second rate for each user can be determined by a weighting factor. The weighting factor of each user is related to the corresponding ranking value. In other words, different users have different second rates. Users with heavy usage (with a lower ranking value) have second rate higher than light usage users (with a higher ranking value).

For example, but not limited to, the weighting factor W of a specific user can be calculated by the following algorithm:

W=2−(ranking value/total number of users*100%).

Next, the license management system 100 may select one or more users from the licensed users based on the target quantity of users estimated to use weighting cost calculation and the ranking result including the priority orders of the respective license users to calculate the cost using corresponding second rate until the implemented license usage rate is lower than the upper limit (step S308).

Specifically, one or more candidate users can be selected from among the users currently using license and those selected candidate users will be prompted to calculate the cost of using license with the weighted second rate. Then, it is further determined whether the number of licenses being currently used is already lower than the upper limit. If the number of licenses being currently used is lower than the upper limit, the weighting cost calculation mechanism is turned off. If not, the previous step will be repeated until the number of licenses being currently used is lower than the upper limit.

In this step, within the mechanism implementation time period, when the usage rate has exceeded the upper limit (an expected target value), the license management system 100 calculates the order of use priority for users who have obtained license. The user with the smallest order will be informed about that the weighted calculation of costs of using license will be started for subsequent use time and if the user does not agree to the terms, the user is advised to withdraw from use as soon as possible in order to release the license. If the user agrees to continue to use the license at a higher cost, the system will continue to confirm the above with the user with the second smallest order, and so on and so forth until a certain number of users have withdrawn from use and that the usage rate is reduced to the target value or below.

For example, assume that the total number of license sets is 100 and that the upper limit is set as “usage rate not exceeding 95.4% during the peak-hour periods”. During the defined peak-hour period, the total number of users is 97, which means that the usage rate during which is 97% exceeding 95.4%. Thus, the license management system 100 starts to rank all the users who have obtained license according to the above-mentioned usage amount and weighting factor and sets a scheduled target. The scheduled target is to prompt two people to withdraw from use (i.e. 97−2=95), so as to reduce the usage rate to 95% smaller than 95.4%. Then, weighting cost calculation is applied to a user A who have the smallest order and a user B who have the second smallest order, thus eliciting their willingness to postpone license acquisition until a non-peak-hour period. If the user A agrees to continue use the license during the peak-hour period at a higher cost, implementation can be continued to prompt a user C who have the third smallest order to withdraw from use, and so on and so forth until the usage rate is reduced to less than 95.4%. By doing so, the usage rate during the peak-hour periods can be controlled within the target value.

Returning to FIG. 2, after the end of the peak-hour periods, in step S210, the license management system 100 adjusts the rate of all the licenses being used back to the first rate to calculate costs of using license. In this step, the cost management device 130 adjusts the cost calculation method of the user who originally adjusted to calculate with the second rate back to the first rate and performs the subsequent calculation accordingly.

For example, if the first rate of the user A is 1 dollar per minute and the second rate of which is 2 dollars per minute with the peak-hour period set as 9:00 to 10:00, when the user A continues to use license from 8:00 to 11:00, the method for calculating the user A's license usage cost is: every minute from 8:00 to 9:00 is calculated as 1 dollar per minute; every minute from 9:00 to 10:00 is calculated as 2 dollars per minute and every minute from 10:00 to 11:00 is adjusted back to be calculated as 1 dollar per minute.

Therefore, the user can decide whether to use the license at a higher cost during the peak-hour periods depending on their own needs and urgency, or the user can postpone license usage until the non-peak hour periods at a regular cost. Through the peak differential price calculation, some users will be willing to postpone their license usage until the non-peak-hour periods. The demand during the peak-hour periods can be effectively distributed, thereby enhancing software usage rate. On the other hand, in order to cope with users' demand changes, records of license usage can be further utilized to readjust the non-peak-hour and peak-hour price calculation rate, re-calculate the records of license usage to adjust the calculation rate basis of the non-peak-hour and peak-hour periods, and reflect it in the new cost calculation, thereby adapting to the new user demand mode.

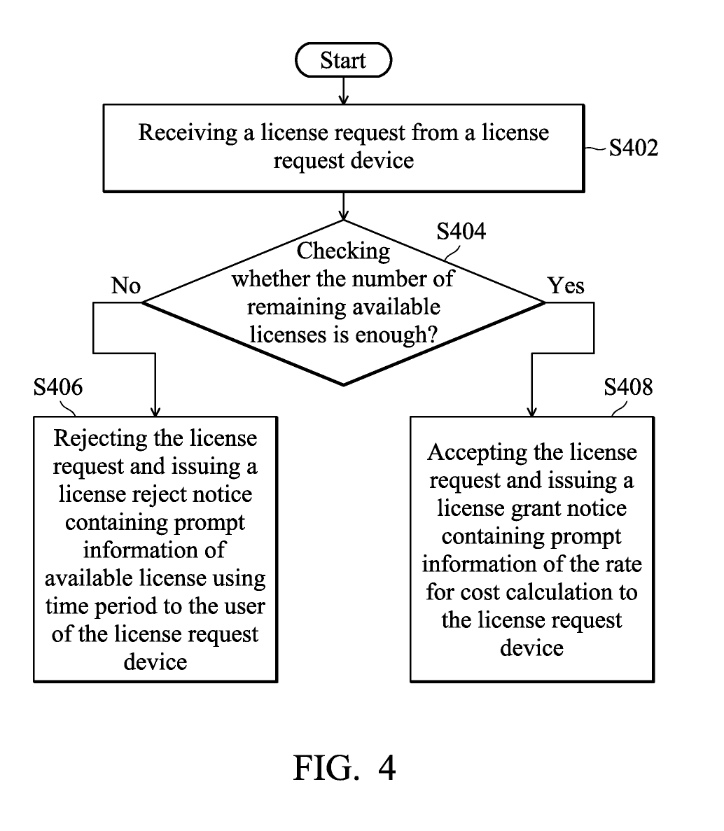

In some embodiments, the license management system 100 may, upon receiving a license request, further decide whether to agree to the license request based on the number of licenses available in the license pool of the license server 200. In addition, when the license request is rejected, the user who failed to obtain the license will receive a prompt on the time that license is likely to be obtained in order to increase their chances of obtaining the license successfully. Please refer to FIG. 4.

FIG. 4 is a flowchart of another embodiment of a license management method of the invention. The license management method can be applied to a license management system such as the license management system 100 of FIG. 1, which can be an electronic device, such as a PDA, a smart phone, a mobile phone, an MID, a laptop computer, a car computer, a digital camera, a multi-media player or a game device, or any other type of mobile computational device, however, it is to be understood that the invention is not limited thereto. In this embodiment, it is assumed that the license management system 100 comprises the record management device 110, the data analyzing device 120, the cost management device 130 and the notification device 140 and it is coupled to the license server 200 and the data server 300 for performing license management on a given number of licenses in the license pool of the license server 200, in which one or more of first devices (i.e. the license usage devices) are using one of the given number of licenses. The license management system 100 can perform the license management method of the present invention through the record management device 110, the data analyzing device 120, the cost management device 130 and the notification device 140.

First, in step S402, when a user of a second device (hereinafter referred to as the license requester) opens the software and requests for a license, the second device sends a license request to the license management system 100 and thus the license management system 100 receives a license request from the second device. The second device is also referred to as the license request device.

In some embodiments, the license management system 100 may further perform a permission verification procedure to determine whether the license request device has the permission to obtain one of the licenses upon receiving the license request from the license request device. When determining that the license request device has no permission to obtain one of the licenses, the license management system 100 rejects the license request directly.

Next, in step S404, the license management system 100 then checks the number of available licenses and determines whether the number of remaining available licenses is enough. To be more specific, the license management system 100 may check whether the number of remaining available licenses in the license pool is enough to be given so as to determine whether to give the license to the license request device. It is to be noted that when the peak-hour period is reached, the term “enough to be given” means that the number of remaining available licenses after the license has been given is sufficient to make the license usage rate less than the upper limit.

When there is no enough remaining available license in the license pool (No in step S404), in S406, it means that the license pool does not have enough licenses to give to the license request device and the license management system 100 rejects the license request and issues a license reject notice containing a prompt information of available license time period to the user of the license request device through the notification device 140. For example, in one embodiment, the license reject notice may include a message of “the current time period from 9:00 to 10:00 is the peak-hour period, the number of used users is too much, please come back to use it at the time period after 10:30”. The user of the license request device may then request the license at the promoted time period. By doing so, the users who have been unable to obtain the licenses can be notified when they can obtain the license so that the user can reopen the software at the corresponding time, thus utilizing their time more effectively, reducing unnecessary waiting, and making license usage more evenly distributed and more efficiently.

When the number of remaining available license in the license pool is still enough (Yes in step S404), in step S408, which means that the license pool has remaining available license to be given to the license request device, the license management system 100 accepts the license request and issues a license grant notice containing a prompt information of the rate for cost calculation to the license request device through the notification device 140 and gives one of the licenses to the license request device. The prompt information of the rate can include information about the time of the peak-hour period, the corresponding weighted cost rate message at the peak hour periods and so on. Therefore, the user of the license request device can obtain the license and starts the use of the software.

In some embodiments, the license management system 100 may further configure an exception list, and a user with a special or emergency situation may apply to the license management system 100 for including in the exception list, which may be added to the exception list by approval. When the cost management device 130 performs the above-mentioned ranking procedure, it may first check whether the user is in the exception list. If the user is within the exception list, the user is excluded in the ranking procedure. The aforementioned ranking procedure is only performed for those users who are not included in the exception list.

In some embodiments, when it is found that the usage rate of the peak-hour period is often higher than the target value after the implementation of the aforementioned weighted cost calculation mechanism, it indicates that the number of available licenses may not be sufficient. In this case, the license management system 100 can refer to statistics data of usage rate in the peak-hour period and advice the system manager whether to purchase additional licenses and the number of licenses needed to be purchased, thus more effectively controlling costs.

Therefore, by the license management system and associated cost-based license management method of the invention, the peak-hour period for the license usage can be set based on license usage records and the license usage status during the peak-hour periods can be adjusted through peak differential price calculation to elicit some users' willingness to postpone their license acquisition until after the peak-hour periods. By making the smallest change, the license management system and associated cost-based license management method of the invention can effectively reduce the software usage rate during the peak-hour periods and increase the software usage rate during the non-peak-hour periods, thereby effectively enhancing software usage rate and increasing optimization spaces. Furthermore, by the cost-based license management method of the invention, since users that fail to acquire successful license can be further notified of a suitable time to apply for license, users that have been unable to acquire successful license will have more chances to successfully acquire license, enabling them to effectively plan their workflows, use time more efficiently and reduce unnecessary waiting.

The methods, or certain aspects or portions thereof, may take the form of a program code (i.e., executable instructions) embodied in tangible media, such as floppy diskettes, CD-ROMS, hard drives, or any other non-transitory machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A computer-implemented cost-based license management method for use in a license management system, wherein the license management system manages a plurality of licenses and calculates respective costs of using license, the method comprising:
setting a peak-hour period according to a historical using record of the licenses;
determining whether the peak-hour period is reached and whether a usage rate for the licenses being used in the peak-hour period is higher than a upper limit;
using a first rate to calculate the cost of using license for all of the licenses being used when the peak-hour period has not been reached or the usage rate for the licenses being used in the peak-hour period is lower than the upper limit; and
selectively using a second rate higher than the first rate to calculate the cost of using license for a part of the licenses being used when the usage rate for the licenses being used in the peak-hour period is higher than the upper limit.

2. The cost-based license management method of claim 1, wherein the peak-hour period is determined by the historical record of average license usage rate of each time period

3. The cost-based license management method of claim 1, wherein the peak-hour period is determined by the historical record of the number of times and/or the number of persons previously unable to obtain one of the licenses for each time period.

4. The cost-based license management method of claim 1, wherein the step of selectively using the second rate to calculate the cost of using license for the part of the licenses being used further comprises:
calculating the number of targets to be calculated cost of using license with the second rate based on the upper limit, and obtaining a ranking result based on the individual historical record of license usage of each of the plurality of users of the used licenses; and
selecting one or more users from the users according to the number of targets and the ranking result to use the second rate for calculating the cost of using license, until the usage rate for the licenses being used is less than the upper limit.

5. The cost-based license management method of claim 4, wherein the individual historical record of license usage of each user further includes one or more of the following information:
a total time the user spent on using license yesterday;
a total time the user spent on using license in the current week; and
a total time the user spent on using license in the current month.

6. The cost-based license management method of claim 4, wherein the number of targets is determined based on the upper limit and the usage rate for the licenses being used.

7. The cost-based license management method of claim 4, wherein each of the users has a corresponding ranking value in the ranking result and the corresponding second rate for each user is based on a weighting factor, wherein the weighting factor is related to the corresponding ranking value.

8. The cost-based license management method of claim 1, further comprising:
determining the number of remaining available licenses among the licenses upon receiving a license request from a device; and
accepting the license request and issuing a license grant notice containing prompt information of the peak-hour period, the first rate and the second rate to the device when determining that the number of the remaining available licenses is enough.

9. The cost-based license management method of claim 8, further comprising:
rejecting the license request and issuing a license reject notice containing prompt information of a time period which is available to obtain one of the licenses when determining that the number of the remaining available licenses is not enough.

10. The cost-based license management method of claim 1, further comprising:
adjusting from the second rate to the first rate to calculate the cost of using license for the selected part of the licenses being used after the peak-hour period has been ended.
